(19) United States
(12) Patent Application Publication
(10) Pub. No.: US 2009/0146782 A1
(43) Pub. Date: Jun. 11, 2009

(54) SINGULATION OF RADIOFREQUENCY IDENTIFICATION TAGS

(75) Inventor: Kevin Cordes, Miller Place, NY (US)

Correspondence Address: Motorola- Amin, Turocy & Calvin, LLP, 127 Public Square, 57th Floor, Key Tower, Cleveland, OH, 44114, US

(73) Assignee: SYMBOL TECHNOLOGIES, INC., Holtsville, NY (US)

(21) Appl. No.: 11/950,896

(22) Filed: Dec. 5, 2007

(51) Int. Cl. H04Q 5/22

(52) U.S. Cl. 340/10.1

(57) ABSTRACT

Systems and methods are provided that facilitate matching an item tag associated with an object identified through a unique item code, thereby identifying the specific object within a set of objects, e.g., singulating said object. Singulation relies at least in part on scanning a barcode that conveys a unique item's identifier code and cross-referencing specific information included in the barcode with data collected from multiple radiofrequency identification tags associated with the set of objects. The specific information can also be employed to discriminate among bins containing multiple tagged objects prior to singulating a specific item. Data included in the singulated RFID tag can be displayed and manipulated. A communication framework facilitates to convey the data to an application that produces actionable information in real time in connection with the singulated object.

### TECHNICAL FIELD

The subject innovation relates generally to identification of tagged objects, and more particularly to singulation of RFID tags based at least in part on a combined approach that relies on probing a unique identifier and an RFID tag associated with said entities.

### BACKGROUND

Advances in communication technology as well as miniaturization trends of electronic devices have made it possible to access and manage large amounts of information wirelessly on the field. By utilizing smart labels such as radiofrequency identification (RFID) tags a wealth of information can be conveyed in a small electronic component that is associated with an object and it typically resides on, or within, the object. Among the typical objects labeled with RFID tags one can encounter consumer products, documents, containers with pharmaceutical drugs, and so on. Said component can be an active or passive radiofrequency identification tag, which can be probed in the field in order to retrieve information stored thereon. The active character is typically conferred to an RFID tag that is self-sufficient regarding power (at least for a finite time interval), whereas passive RFID tags are energized at the time of being probed by a device that collects the information stored in the tag.

Ever reducing tagging costs associated with RFID labels, driven primarily by advances in RFID technology and increases in market and business opportunities, have rendered RFID tags successful at identification of groups of like objects, such as pallets, lots, or bins, rather than for labeling of individually tagged, disparate objects. The reason for not having harnessed fully yet the versatility and convenience of smart RFID labeling is that conventional RFID label readers probe multiple tags simultaneously when retrieving information stored thereon. Thus, there is a need in the art for technically and commercially effective RFID singulation techniques, e.g. systems and methods to identify a single tagged entity among a multiple tagged objects.

### SUMMARY

The following presents a simplified summary of the invention in order to provide a basic understanding of one or more aspects of the invention. This summary is not an extensive overview of the invention. It is intended to neither identify key or critical elements of the invention, nor to delineate the scope of the subject invention. Rather, the sole purpose of this summary is to present some concepts of the invention in a simplified form as a prelude to the more detailed description that is presented hereinafter.

Systems and methods are described herein that facilitate matching an item tag which can be a radiofrequency identification tag and is contained within an object identified through a unique item code, thereby identifying the specific object within a set of objects. Such identification is characterized as object singulation. According to an aspect, singulation relies at least in part on scanning a barcode that characterizes the item's unique identifier code, and cross-referencing specific information included in the barcode with data collected from multiple radiofrequency identification tags associated with the set of objects.

Scanning and data collection can be effected via a barcode scanner component and a radiofrequency identification reader/writer component, and cross-reference of the gathered data in the barcode and item tags can be accomplished through a dedicated component that parses through the available data and matches information in a specific field carried in the item tag with an object identifier(s) conveyed in the barcode. The specific information can also be employed to discriminate among bins containing multiple tagged objects prior to singulating a specific item. Data included in the singulated RFID tag can be displayed and manipulated, as well as communicated among various operators through a communication framework that includes wired and wireless communication networks. The communication framework also facilitates conveying the data to an application that produces actionable information in real time in connection with the singulated object. The actionable information can include data on (i) inventory and availability of a specific item, (ii) data on sale on specific locations, (iii) location in a distribution route, (iv) personnel involved in handling an object and clearance level associated required to handle the object, and so forth.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is a block diagram of an example system that singulates an item within a set of items, wherein the singulated item is tagged with an RFID tag and a unique item barcode.

FIG. 2 illustrates a block diagram of an example singulation component in accordance with an aspect disclosed herein.

FIG. 3 is a schematic example display associated with a display component in a singulation component according to an aspect described in the innovation.

FIG. 4 illustrates a block diagram of a system that facilitates “directed binning” according to an aspect described in the subject innovation.

FIGS. 5A and 5B illustrate example systems to convey data along various stages of an item and trail said item, in real time, at disparate geographic locations based on singulation and data manipulation.

FIG. 6 presents a flowchart of an example method for singulating an item tag associated with a tagged material entity.

FIG. 7 presents a flowchart of an example method for singulating an item employing a reference datum.

FIG. 8 presents a flowchart method for manipulating data associated with a material item through singulation of an item tag residing in the item.

FIG. 9 illustrates an example handheld singulation component in accordance with an aspect of the subject innovation.

FIG. 10 illustrates a block diagram of an example device that exploits the subject innovation.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “system,” “module,” “framework,” “application,” and the like are intended to refer to: electromechanical, computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g. data from one component interacting with another component in a local system, distributed system, and/or across a network such as the Internet with other systems via the signal).

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Systems and methods are described herein that facilitate matching an item tag which can be a radiofrequency identification tag and is contained within an object identified through a unique item code, thereby identifying the specific object within a set of objects. Such identification is characterized as object singulation. According to an aspect, singulation relies at least in part on scanning a barcode that characterizes the item's unique identifier code, and cross-referencing specific information included in the barcode with data collected from multiple radiofrequency identification tags associated with the set of objects. Data included in the singulated RFID tag can be displayed and manipulated, as well as communicated among various operators through a communication framework that includes wired and wireless communication networks. The communication framework also facilitates conveying the data to an application that produces actionable information in real time in connection with the singulated object. Next, aspects of the systems and methods associated with item singulation are discussed in detail.

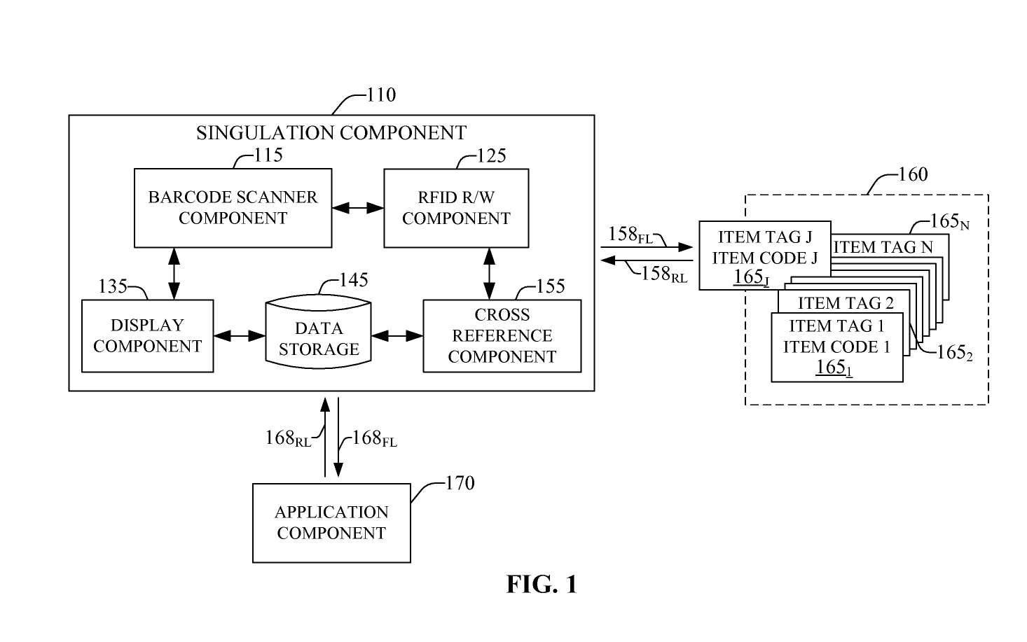

FIG. 1 is a block diagram of an example system 100 that identifies a specific item within a set of items (e.g., singulates said item), the item tagged with an RFID tag that matches a unique item code. System 100 comprises a singulation component 110 that probes a set of items 160 (e.g., items 165₁-165_{N}) and collects data associated with a single, specific item (e.g., item 165_{J}). A barcode scanner component 115 and an RFID read/write (RFID R/W) component 125 can probe an item code (e.g., item code J) and an item tag (item tag J), respectively, within the set of items (e.g., items 165₁-165_{N}). In an aspect, an item code can be a barcode that is a linear symbology code, which can include, but is not limited to including, a universal product code, a European article numbering code, a universal standard book numbering code, a rational codabar code, a postal numeric encoding technique code, shipping container code, a serialized shipping container code, a health care industry barcode code, a code 39 standard, a code 93 standard, or a code 128 standard. Additionally, the barcode can be a two-dimensional barcode that can include, but is not limited to including, a PDF417 code, an Aztec code, a quick response (QR) code, a codablock code, a code 1, a code 16K, a code 49, a CP code, a data glyph code, a datastrip code, a dot code A, a maxicode code, a minicode code, a smartcode code, a supercode code, a snowflake code, an ultracode code, a paperdisk code, or a reduced space symbology code. It is noted that substantially any linear symbology barcode or substantially any two-dimensional symbology barcode can be utilized in connection with the subject innovation; the example code presented hereinbefore serving illustrative purposes rather than limiting purposes. The probe of items/object is effected through a forward link (FL) 158_{FL} and data associated with a singulated item (e.g. item 165_{J}) is collected through a reverse link (RL) 158_{RL}. FL and RL can be wireless links, wired links, or a combination thereof. Collected data can be conveyed in a display component 135 or stored in data storage 145. A cross reference component in singulation component 110 matches a datum contained in an item RFID tag (e.g., item tag J associated with item 165_{J}) that is referenced by a unique identifier code (e.g., item code J associated with item 165_{J}). It should be appreciated that the data collected can encompass data contained in all item tags (e.g., item tags 1 through N) associated with the set of items (e.g., items 165₁-165_{N}), or it can be data associated with a single item tag.

In an aspect, can present operational diagnosis of instruments that a technician is probing and desires to singulate in order conduct repairs. Additionally, display component 135 can facilitate an operator to place a call utilizing voice over internet protocol (VOIP) for on-the-field technical support, to send a message (based on short message service (SMS) or an instant message (IM) service), as well as other forms of electronic communication such as email. Applications that provide such functionality accessed through display component 135 can reside in application component 170. Below, further aspects of display component are discussed.

Data storage 145 can also be employed as a data cache when performing additional item tag singulation acts (see below). Data contained in a singulated item tag can include environmental data measured by the tag at the time of singulation or prior to singulation, such as temperature, pressure, humidity. This data can be acquired by each item tag associated with an item (e.g., item 165₂).

Singulation component 110 can be (i) compact or (ii) disjoint. In case (i), components such as barcode scanner component 115, RFID R/W component 125, display component 135, cross reference component 155, and data storage (e.g., data storage 145), that comprise singulation component 110 can be housed in a single physical element. The physical element can integrate multiple parts, e.g. solid state integrated circuits, power sources, detectors, transponders and transceivers for radiofrequency communication, and so on, or it can be a miniaturized (all-solid-state) monolithic element comprising devices, detectors, and power and light sources; depending on design power sources that supply power to bar scanner component 115, RFID R/W component 125, or display component 135, can be batteries or fuel cells, wherein batteries can be complemented or replaced with solar cells which can be embodied in high-efficiency thin-films solar cells or quantum-dot based solar cells. Light sources that can be employed in barcode scanner component 115 can include quantum-dot based lasers or solid-state light emitting diodes. A compact singulation component 110 can be portable, being either tethered or wireless (see below).

In case (ii), components that comprise singulation component 110 are distributed; for instance, barcode scanner component 115 can be based in part on a laser reader embodied in a multi-mirror laser scanner or a pen/wand light reader, a charge-coupled device in a photosensitive element (imager) (e.g., a “CCD camera”), or a set of visible-infrared (vis-IR) cameras distributed in an environment containing a set(s) of items; RFID R/W component 125 can be in a separate location; and display component 135, data storage 145 and cross reference component 155 can be in another location. Cameras can be connected to a wide area network (WAN) such as the internet and can be controlled remotely from a control center in a plant, distribution/dispatch center, an operator's residence, and so forth. It should be appreciated that control of the cameras provide a degree of controlling environmental aspects such as storage and packaging of the set of items that is interrogated with a singulation component 1 10. Display component 135 can reside in a control center that controls cameras that are part of a barcode scanner component 115. Moreover, display component 135 can be mobile, wireless or tethered, and placed on a disparate location with respect to barcode scanner component 115 and RFID R/W component 125. In an aspect, display component 135 can be attached to a vehicle embedded in a vehicular navigation system, it can embodied in the screen of a mobile computer, a mobile phone, or a personal digital assistant (PDA).

Application component 170 can receive data from singulation component 110 via FL 168_{FL}, and convey data to said component through a reverse link RL 168_{RL}. Data is processed according to one or more applications (not shown) that can reside in said application component 170. As an example, application component 170 can be embodied in a server computer that manages a data warehouse application. Such data warehouse application can be access by different corporate and operation layers in an enterprise; for instance, (i) management can access near real-time data of sales, with access to location information which can be contained in an item tag (e.g., item tag J in item 165_{J}), marketing can access store profile information associated with a singulated item at the time of check out, (iii) logistics can access inventory information or storage information and plan distribution routes, or modify distribution routes on near real-time; (iv) service can access operation condition of a singulated component and perform remote maintenance, which can entail conveying data through reverse link 168_{RL} to singulation component 1 10. It is noted that application can provide multiple functionalities to singulation component 110, such as email, instant messaging, short message service, VOIP, and the like.

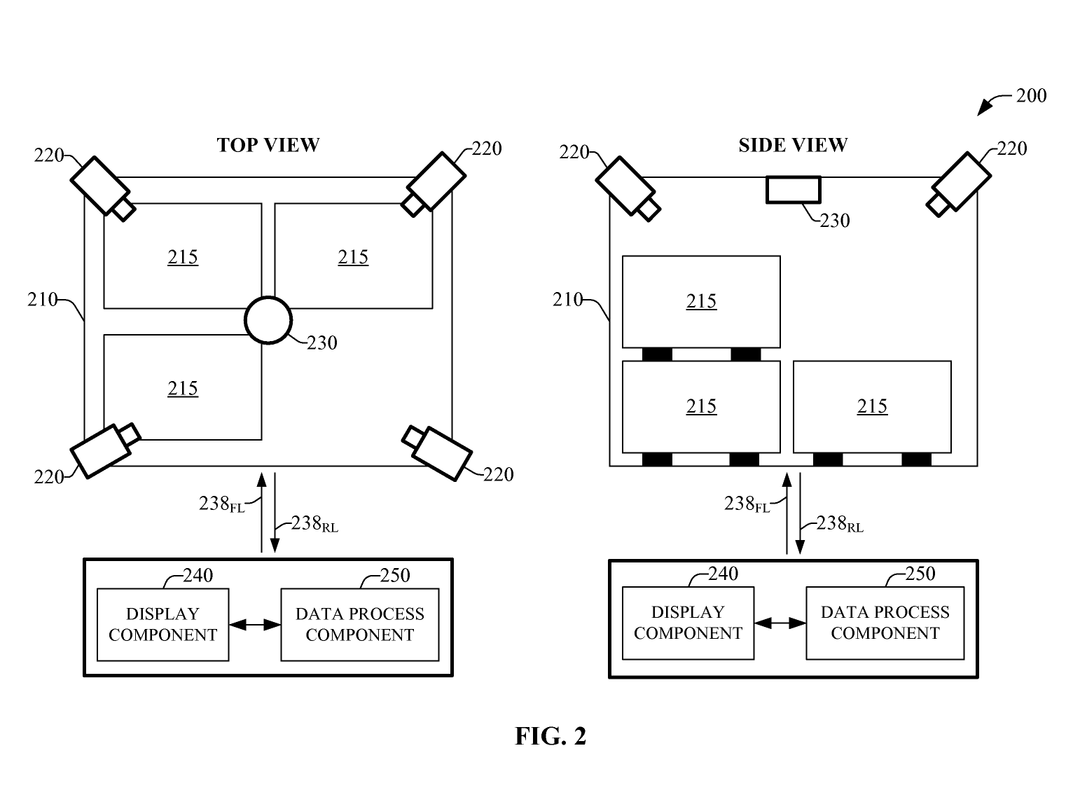

FIG. 2 illustrates a block diagram 200 of an example disjointed singulation component. Such component comprises a barcode scanner component embodied in four vis-IR cameras 220 and an RFID R/W component 230. Cameras 220 are mounted in the top corners of an enclosure 210, such an enclosure can be a storage room, a transportation container, a cargo trailer, a portable container, etc. It is noted that enclosure 210 can have one of multiple shapes even though it is illustrated as a right-angle box to facilitate presentation and discussion thereof As discussed above, cameras can be controlled remotely, such control provides for position and focusing the cameras so as to scan barcodes present in items 215. In an aspect, such barcodes (not shown) can be placed in various positions on the surface of each item 215 to guarantee a viable line-of-sight after adjusting camera 215 orientation and focus. In block diagram 200, four items 215 lay in enclosure 210; however, it should be appreciated that the number is illustrative and the number of items 215 that can be accommodated in enclosure 210 depends on the characteristics of said items 215 and said enclosure 2 10. It should be further appreciated that the presence of enclosure 210 is for illustrate purposes and not a way to limit the aspects of a disjoint singulation component. Vis-IR cameras 220 (e.g., a barcode scanner component) and RFID R/W component 230 are coupled to a display component 240 and a data process component 250 via communication links 238_{FL} and 238_{RL}. As discussed supra, such links can correspond to a wired network, a wireless network, or a combination thereof. Data process component can comprise a data storage (e.g., data storage 145) and a cross-reference component (e.g., component 155). Additionally, data process component 250 can include an application component 170.

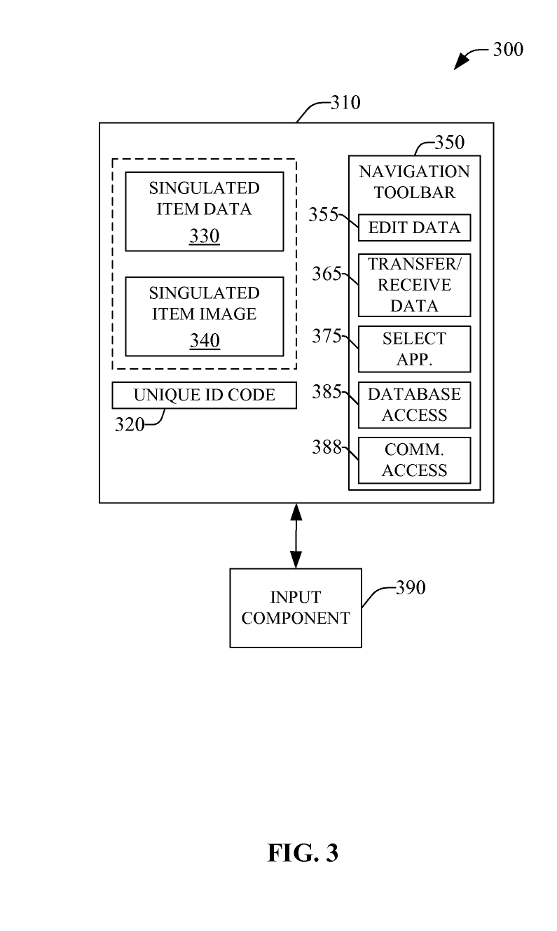

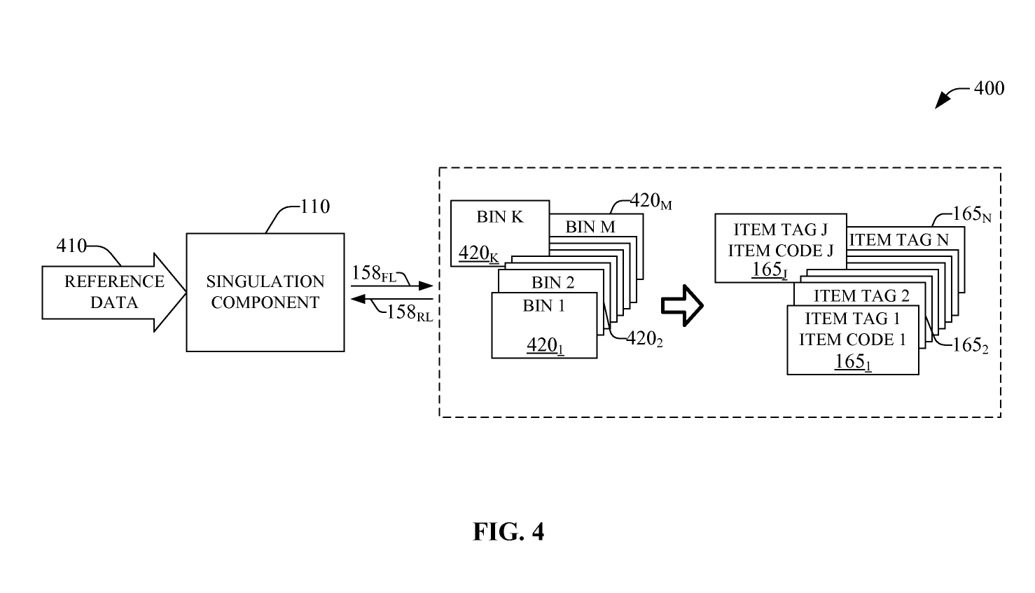

FIG. 3 illustrates an example display 300 associated with a display component 135 in either a compact or disjointed singulation component. Display 300 comprises two main elements: a display area 310 wherein information related to singulation component 110 can be rendered, and an input component 390 that provides a user-machine interface. Upon singulation, display area 310 can display the unique identifier (ID) code 320 associated with a singulated item tag (e.g., item tag J in item 165_{J}), and indicia associated with the singulated item: singulated item data 330, and singulated item image 340. Data 330 can correspond to substantially all data that is available in the singulated item tag, the nature and volume of data typically depends on the type of tag that is singulated, e.g., active or passive. Singulated item image 340 can render an image of a singulated item that incorporates data associated with the item, such as temperature profile, pressure profile, or a time evolution of a specific parameter associated with the item, presented in singulated item data panel 330. Rendering a singulated item's data can facilitate maintenance, test, or repairs of the item. Example navigation toolbar 350 displays an Edit Data 355 option that allows a user interacting with a singulation component (e.g., singulation component 110) to modify data available in a singulated device, such data can be the data presented in singulated item data 330. Typically upon selection of Edit Data 355, new indicia can be displayed associated with tool to edit the data associated with the singulated device. Upon modification of such data, an RFID R/W component (e.g. RFID R/W component 135) can (re)write data into the item tag in the singulated item. Edit Data 355 can also be employed to modify unique ID code 320 to perform an alternative, or additional, tag singulation (see below; FIG. 4).

In addition, example Navigation Toolbar 350 provides with a Transfer/Receive Data 365 tool which provides for conveying data in a singulated item tag to an application component (e.g., component 170), as well as receiving data from said application component. It should be appreciated that data can also be received from a disparate singulation component or substantially any portable or stationary device that can be connected to the singulation component associated with the display component that renders display 300. Moreover, data can also be received from another singulated item tag (see above), or it can be received from the singulated tag via a measurement component that can reside in the tag and measures properties of the tag's environment (see above). Conveying or receiving data can be accomplished trough a data transfer port that can be based on wireless technology, such as infrared communications, or wired technology, e.g. a serial port connected to a data source or sink. Moreover, example Navigation Toolbar 350 includes a Select Application 375 icon that allows a user to determine a specific target application, for example in application component 170, which is to employ the singulated data. Such application can be one of multiple applications as discussed above. Furthermore, example Navigation Toolbar 350 can provide access to a database that can be located remotely, for example in an application component 170, or in a disparate network location. Data existing in said database can be employed within Edit Data 355 to alter data existing in the singulated item tag. Further yet, example Navigation Toolbar 350 can provide access to communication capabilities (IM, SMS, VOIP, etc.) via a Communication Access layer 388, which can enable peer-to-peer communications among operators of disparate singulation components.

In one aspect, input component 390 can be embedded within display area 310, as it can be the case when input of data, information requests, and navigation commands is achieved via a touch-screen—hardware, software, and firmware associated with a touch-screen mode of inputting information can comprise input component 390. In another aspect, input component can include a keyboard, which can include navigation keys and other special keys. In yet another aspect, input component can correspond to hardware, software embedded in a computer-readable medium (e.g., stored in a memory in singulation component 110 or in a device including singulation component 1 10, or firmware, for entering information or requests for information through voice commands. In a further aspect, input component 390 can include a biometric input sub-component that can introduce a security feature to the input component. For example, in circumstances that controlled substances are being manipulated (e.g., transported, shelved, replenished, and so on), only authorized personal can have access to the features accessible through navigator toolbar 350. Moreover, in scenarios in which items probed contain classified data, e.g., weapons, biological agents, toxic substances, radioactive fuel, etc., biometrics verification can ensure that personnel access data and available features compatible with the personnel member level of clearance.

FIG. 4 illustrates a block diagram of a system 400 that facilitates “directed binning.” System 400 includes a singulation component 110 and communication links 158FL and 158_{RL}, with features and characteristics as described above in connection with FIG. 1. Smart binning relies on reference data 410 provided to singulation component 110, such data can be entered via a display component (e.g., display component 135 or 240). Reference data can be a unique ID code (e.g., a barcode) or it can be a generic datum associated with a specific item known to be contained within a set of bins (such as pallets, multiple files, etc.) including bins 420₁-420_{M} in a tagged item (e.g., item 165J). Reference data 410 can be a date of manufacture; a date of expiration, in case of perishable foods or cultured material for laboratory analysis; a lot number; a specific processing history like a trail record of sorting facilities in which an item has been processed, or a trail of assembly lines that an item traversed during assembly; a name of handler or operator involved in assembling, sorting, or delivering a product; type of materials employed to manufacture an item, e.g., type of paint and paint provider; and so on. RFID R/W component (not shown) in singulation component 110 can be utilized to probe the set of bins and discriminate one (e.g., bin K 420_{K}) or more bins (bin 1 420₁ and bin 2 420₂) that include reference data 410. Subsequently a further screening effected with barcode scanner component 115 in conjunction with cross-reference component 155, which provides an association between reference data 410 and a unique ID code after component 155 parses the data, affords item tag singulation. Directed binning can optimize searching for specific items and offers the advantage of avoid container displacement and rearrangement.

The following example illustrates, but not limits, directed binning. Consider an office that maintains a paper trail (e.g. documents) of cases it handles, such an office can be a medical doctor's office, a law firm, or the like. Files containing documents associated with respective case can be kept and maintained in bins according to case starting date, to client identification, to doctor or attorney responsible for the case, etc.; the files are tagged with an RFID tag, which can be active or passive, and with a barcode reflecting a unique identifiers or reference identifiers albeit not unique. In such scenario, directed binning can operate in the following manner. A person/operator enters a datum (e.g., reference data 410, which can be a case number) in a singulation component (e.g., component 110, which can be a compact or disjointed singulation component); for instance, the datum (e.g., a patient condition, or address, or credit card number; or a case identifying code) can be conveyed wirelessly from a computer that the operator has access to. In the case the singulation component is compact, operator can read multiple bins of files (which, for example, can embody bins 420₁-420_{N}), and thus identify a file bin (which can embody bin K 420_{K}) containing the specific datum. Once the file bin has been identified, the operator scans barcodes in the direct bin, in that instance cross-reference component 155 in the singulation component identifies a unique identifier that can be associated with the available datum and singulates the file, or item tag that belongs to it, notifying the operator in a display component 135. It should be appreciated that component 155 can accomplish such an association by parsing available data.

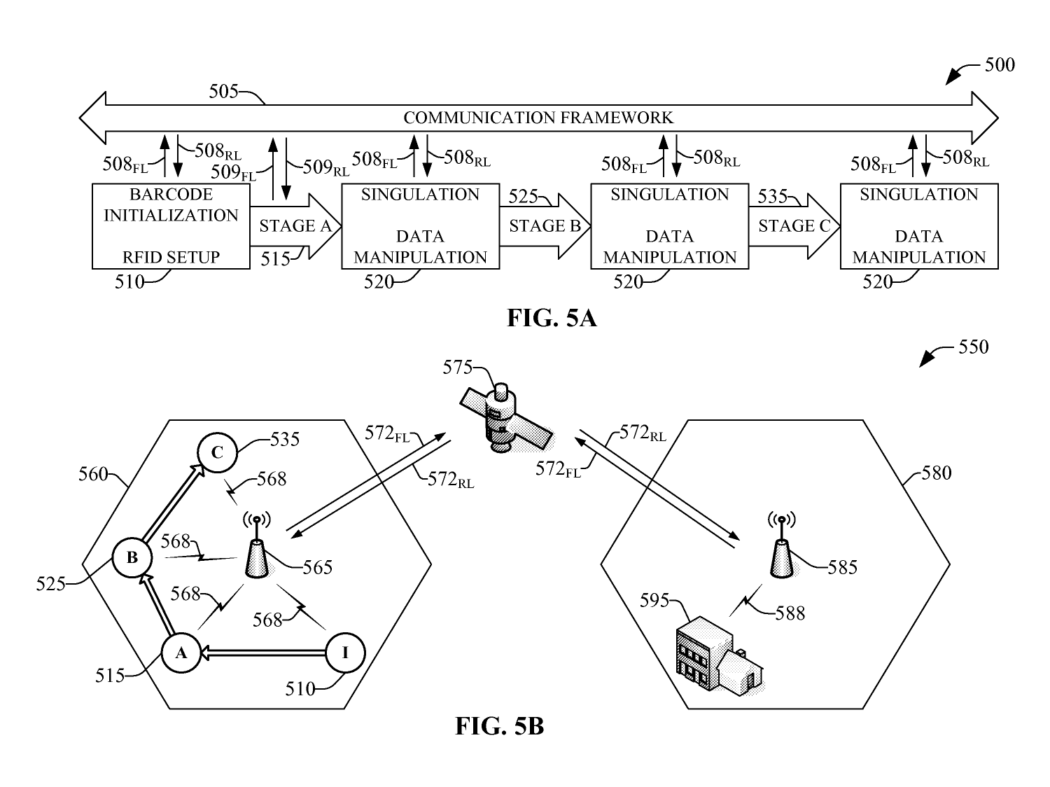

FIG. 5A is a schematic diagram 500 of a scenario that exploits singulation as described hereinbefore, and a communication framework and multiple communication links in order to convey data along various stages of an item, or items. Data related to an item(s) and generated through a singulation component 110, and subsequent data manipulation, can be conveyed to different locations that can be a part of communication framework 505 associated with the item(s). Data is conveyed through communication links 508_{FL} and 508_{RL} at the various stages, e.g., state A 515, stage B 525, or stage C 535, of the item(s). As discussed supra, forward link 508_{FL} and reverse link 508_{RL} can correspond to wired network links (e.g., T1/E1 lines, fiber optic links, twisted-pair links, and so forth), or wireless network links (e.g., an air-interface and a set of physical channels conveyed through said interface) operating within various protocols for wireless communication. It should be appreciated that wireless communication includes terrestrial radio communication—indoor and outdoor—as well as satellite communications.

An initial, configuration stage for an item can comprise a barcode initialization and an RFID setup 510. It is noted that barcode initialization can be conducted in a centralized location (e.g., a distribution center, an enterprise headquarters), or it can be performed in the field by printing a barcode (e.g., item code J associated with item 165J) using a high resolution printer and a barcode printing application. It should be appreciated that a printer, portable or otherwise, as well as the printing application can be a part of singulation component 110, or application component 170. The item's stage A 515 can include displacement within a specific geographic area (e.g., a state, a province, a country, as well as the interior of a manufacturing plant, an assembly line, a sorting facility, and so forth) and can culminate with singulation and data manipulation 520 in the manner described supra. Data is conveyed, received, or a combination thereof, via 508_{FL} and 508_{RL}. For example, displacement involved in stage A 515 can originate is transportation of a manufactured item from a production plant to a wholesale distribution center, or from a storage center in a Customs facility to a first planned stop in an exportation/commercialization route.

Subsequently, said item is involved in a stage B 525 that, similarly to stage A 515, culminates in a singulation and data manipulation 520. Collected data (e.g. through a singulation component 110) can be conveyed through FL 508_{FL}, and data manipulation can result in data reception via RL 508_{RL}. It is noted that stage B 525 can be a programmed continuation of stage B as a part of, for example, a distribution route of items, or stage B 525 can be associated with carrier transfer during a delivery route—e.g. at stage A 515 the item is loaded in a transportation vehicle that carries the item from a sorting facility to a carrier (e.g., plane, train, bus, and the like) hub, whereas stage B 525 can correspond to the item transfer from one carrier embodiment (e.g., train) to a second transportation means (e.g., plane). Stages A and B can be followed by a stage C which similarly to said previous stages can culminate in a singulation and data manipulation 520 with ensuing data transfer effected via links 508_{FL} and 508_{RL}. Following the example described supra, stage C can be a final transportation leg in a delivery route, such as truck delivery. It is noted that in stage A 515, stage B 525, and stage C 535, information related to arrival times, handlers, geographic area, time-dependent environmental parameters (such as temperature, pressure, mechanical tress, which involves deformation of the item including its housing or casing) to which the item has been submitted during a specific stage, can be entered into an item tag (e.g. item tag N associated with item 165_{N}) and retrieved through an application. It is noted that during each state (e.g. transportation data can be conveyed to the item's tag via wireless links, for example links 509_{FL} and 509_{RL}).

FIG. 5B illustrates an example system 550 that allows to trail an item, in real time, at disparate geographic locations based on singulation and data manipulation at disparate stages of the item. System 550 includes a wireless access point 565 that services a cell 560 wherein an item is transported. Disparate locations in cell 560 are associated with stages 510, 515, 525, and 535 as described supra. Wireless communication link 568 provides data traffic among access point 565 and a singulation component 110 (not shown) employed to manipulate data in a singulated item tag at stages A through C. In an aspect, data associated with the singulated item tag can be conveyed via a satellite communication FL 572_{FL} to satellite(s) 575, which can transmit the data to a wireless access point 585 in a disparate geographic cell 580. Communication from access point 585 (that services cell 580) to satellite(s) 575 and from satellite(s) 575 to access point 565 (that services cell 560) is accomplished, respectively, through satellite communication FL 572_{FL} and satellite communication RL 572_{RL}. Access point 585 can convey data it receives from satellite(s) 575 to a location 595 that can centralize the information associated with a singulated item in stages A through C in geographic cell 560. Such traffic is afforded by a wireless link 588. In an aspect, location 595 can be a plant wherein the singulated item has been manufactured; it can be a distribution center that manages distribution routes to deliver the singulated item to retailers or other customers; or it can be a regulating agency that oversees adequate handling of controlled substances or weapons. It should be appreciated that satellite(s) 575 can be a global positioning system that can provide location information of an agent that transports the singulated item through cell 560.

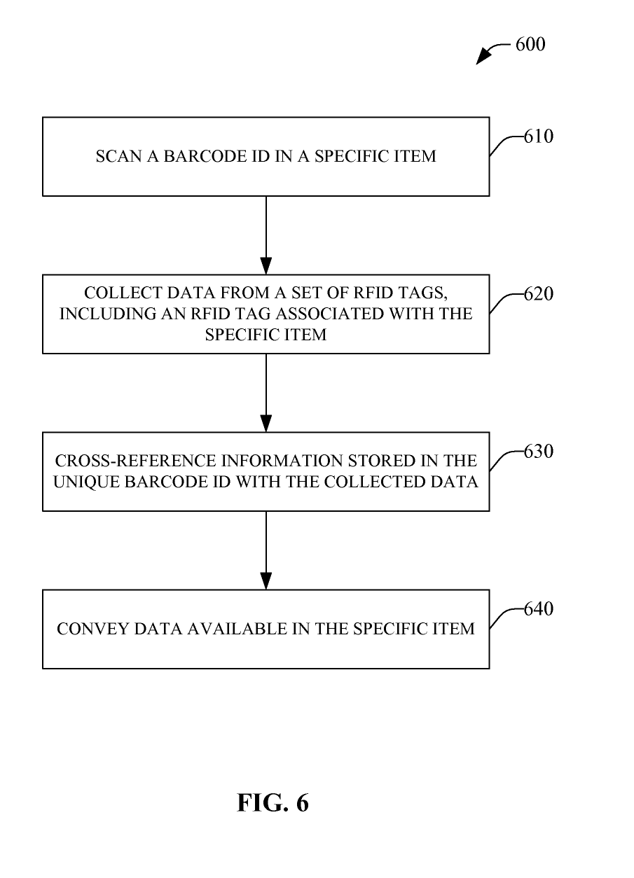

In view of the example systems presented and described above, methodologies that may be implemented in accordance with the disclosed subject matter, will be better appreciated with reference to the flowcharts of FIGS. 6-8. While, for purposes of simplicity of explanation, the methodologies are shown and described as a series of blocks, it is to be understood and appreciated that the disclosed aspects are not limited by the number or order of acts, as some acts may occur in different orders and/or concurrently with other blocks from what is depicted and described herein. Moreover, not all illustrated acts may be required to implement the methodologies described hereinafter. It is to be appreciated that the functionality associated with the blocks may be implemented by software, hardware, a combination thereof or any other suitable means (e.g., device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 6 presents a flowchart of an example method 600 that facilitates singulation of an item tag associated with a tagged material entity. At act 610, a barcode identifier containing a unique identifier for a specific item is scanned. Scanning can take place via a barcode scanner component 115, which can be embodied in a laser scanner or a camera (e.g., a CCD imager, or a vis-IR camera) and is a part of a singulation component 110. At act 620, data is collected from a set of RFID tags deployed in a set of items (e.g., items 165₁-165_{N}), wherein the set includes an RFID tag (e.g., item tag 1 165₁) associated with the specific item (e.g., item 165₂). In an aspect, data is collected wirelessly through links such as 158_{FL} and 158_{RL} (FIG. 1) by an RFID R/W component 125. At act 630, unique information associated with the barcode scanned in the specific item is cross-referenced with the collected data; such an act includes parsing the collected data. As discussed in connection with FIG. 1, such information can be a unique identifier, for example, a serial number, a multi-bit cyclic redundancy check (CRC), a multi-bit checksum code, a universally unique identifier, and so on. It should be appreciated that substantially any unique identifier can be utilized with the subject innovation, and that such example unique identifiers are disclosed for illustration and not by way of limitation. The cross-reference can be performed by a cross-reference component 155 that is part of a singulation component 110. At act 640, data available in the specific item, which corresponds to data in the singulated item tag, is conveyed to an application for processing. In an aspect, the application can reside in an application component, which can be embodied in a server computer that operates as it is known in the art. Data included in the singulated item tag can be employed according to the instance in which said tag is singulated. For example, in a retail enterprise the data can be utilized to maintain an inventory database and determine order volume necessary to replenish a store, as well as for distribution efforts like arranging distribution routes and distribution volume.

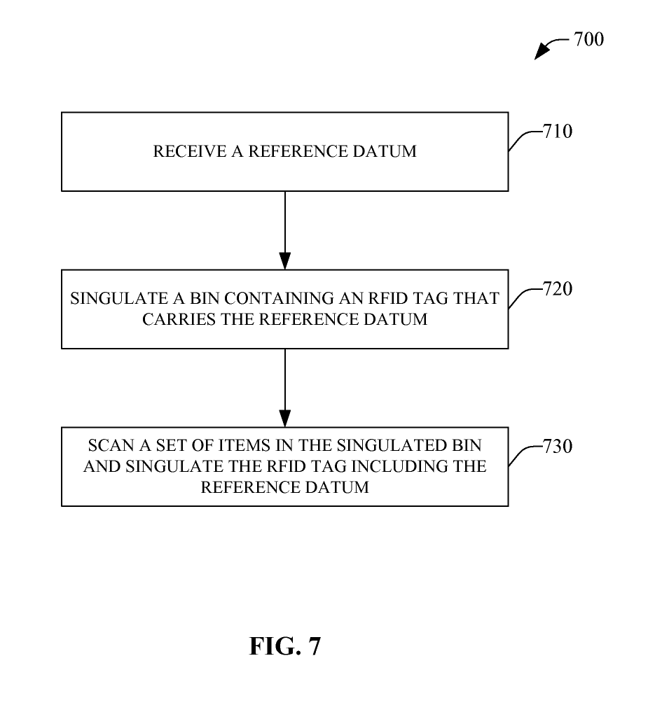

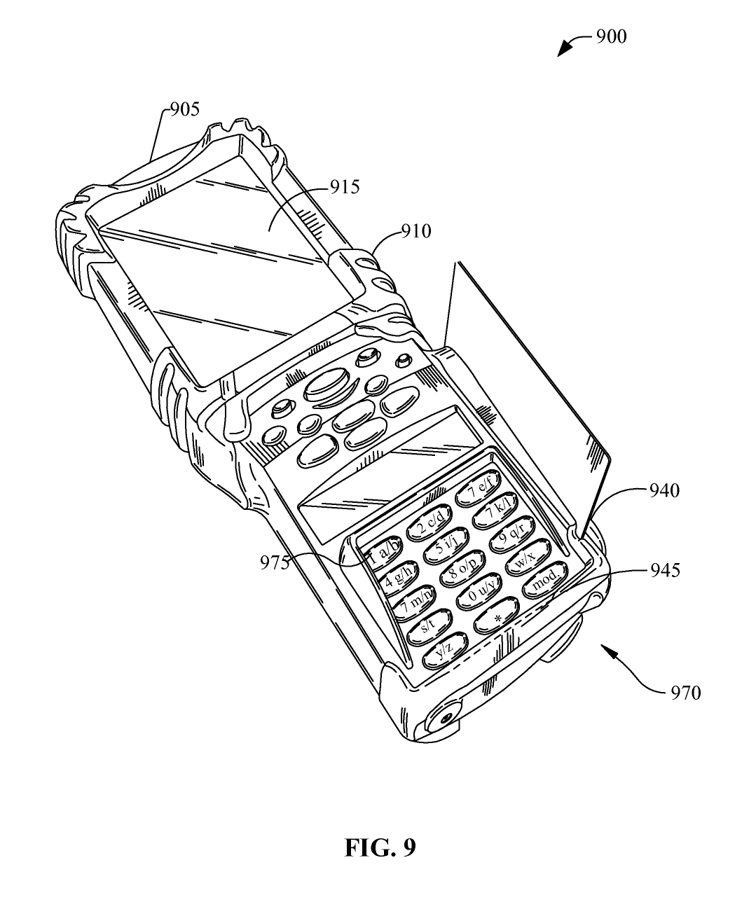

FIG. 7 presents a flowchart of an example method for singulating an item employing a reference datum. At act 710 a reference datum is received. For example, the datum can be generated by an operator or it can be produced by an application (the application can reside in an application component, such as application component 170). Additionally, the datum can be related to multiple characteristic aspects of a material entity or item (e.g. item 165_{J}). Typically, the datum is contained in an RFID tag conferred to the item by a manufacturer, a retailer, a handling service, a carrier service, or the like. At act 720, a bin containing multiple items is singulated based on the reference datum, wherein the singulated bin includes an item tagged with an RFID tag that comprises the datum. At act 730, barcodes in a set of items within the singulated bin are scanned, e.g., with a barcode scanner component 115 that is part of a singulation component 110, in order to singulate the RFID tag including the reference datum. Scanning can be performed by an operator with a compact, portable singulation component 110 (see below; FIG. 9) or via cameras, or laser scanners/pens, which can be part of a disjointed singulation component 110.

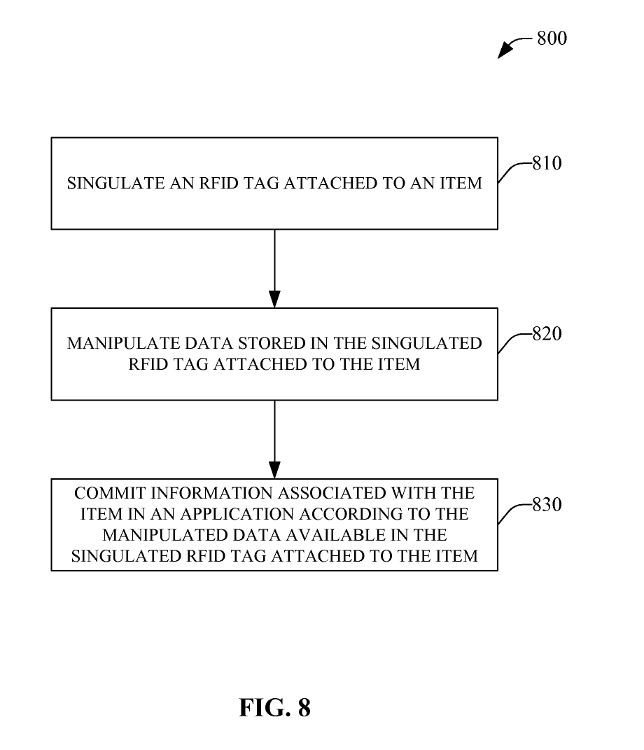

FIG. 8 presents a flowchart method for manipulating data associated with a material item through singulation of an item tag residing in the item. At step 810 an item's RFID tag is singulated. Such singulation can proceed according to methodology 600 described supra. At step 820, data stored in the singulated RFID tag attached to the item is manipulated. For example, at various stages of a supply chain (FIG. 5), data in the tag can be updated with information relevant to the item such as date of manufacture, expiration date, country of origin, an the like. Additionally, in sensitive item such as weapons, ammunition, and biological agents, data associated with security features embedded in the RFID tag, such as a digital signature, a voice signature, clearance level; manipulation/assembly procedures, handler/operator; and destination, traffic route, etc., can also be manipulated through at different stages through delivery of the sensitive item. In an aspect, data manipulation can be accomplished through a display component 135, and associated input component 390, in a singulation component 110. At step 830, information associated with the item is committed, or updated, in an application (residing in an application component 170, for example) that employs said information according to the manipulated data available in the singulated RFID tag. As an example, a record of said data manipulation can be employed in an audit of appropriate conduct or practices by personnel responsible for handling of the sensitive item. Moreover, the information can be employed to verify expenses incurred with shipping and handling of sensitive materials, or shipped items in general.

FIG. 9 illustrates an example compact handheld singulation component 900. Such singulation component 900 includes a consolidated barcode scanner component and RFID R/W component at an end window 905 in the handheld terminal. It is noted that singulation component 900 also includes a pen/wand light reader (not shown) that complements the barcode scanner component, and can act as a stylus to operate the singulation component through a display component 915 (see below). A solid-state light-emitting diode LED (not shown) can act as the light source for the consolidated barcode scanner. A quantum-well or quantum-dot based IR light source (not shown) can also be employed to minimize noise in the detection/scanning of a bar code. Visual or aural indicia from display 915 or a speaker (not shown) can be presented to an operator of singulation component 900 to indicate that a barcode has been successfully imaged and decoded, as well as data has been successfully collected from a set of item tags. Multiple antennas (not shown) facilitate operation of the consolidated RFID R/W component 905 for wireless communication with an RF access point; and an IR transceiver (not shown) for communication with an IR access point. Beamforming effected through said multiple antennas, in conjunction with a processor and additional electronic circuitry (not shown), can improve signal-to-noise interference by “focusing” the RF radiation emitted/received during data collection from item tags. It is noted that antennas and associated electronic component for wireless communication also facilitate communication singulation component 900 with an external application component (not shown) via forward and reverse network links (not illustrated).

Compact handheld singulation component 900 includes a housing 910 which can be constructed from a high strength plastic, metal, or any other suitable material. Singulation component 900 is wireless and portable and includes a display component 915 that renders data collected from barcode unique identifiers, e.g., item code 2, and item tags (e.g. item tags 1-N). Additionally, display 915 presents an operation with functions to display and manipulate data, communicate the data to another operator, device, or location, as well as other information relating to ordinary operation of a typical wireless, handheld device. It should be appreciated that the various functions that can be accessed through display component 915 can be executed, via a processor, by singulation component 900. In an aspect, the display 915 can provide for a touch screen interface that can employ capacitive, resistive touch, infrared, surface acoustic wave, or grounded acoustic wave technology.

An input component embodied in a keypad 970, which can employ a varying surface and a raised grip protrusion 945 to facilitate utilization of the handheld singulation component 900 in the field—e.g., during transportation of object bins such as 420₁-420_{M}. In particular, the raised grip protrusion 945 facilitates holding singulation component 900 in a secure position. The keypad 970 can include a top cover and a bottom cover that can be over molded around a common boundary. In an aspect, the top cover and the bottom cover can sandwich a plurality of associated keypad components (e.g., flex members, electroluminous panel, a silicone membrane with a plurality of keys thereupon printed circuit boards, LEDs, and the like). The common boundary can be formed by a surface area and/or line perimeter common to the top cover and the bottom cover, (e.g. a contact surface between top and bottom cover, a surface encapsulating the keypad components, edges of the stacked components and the like.) Typically, materials employed for fabricating the keypad's 970 top cover and bottom cover can include various types of polycarbonates, thermoset plastics, thermoformed plastic, and typically material that are capable of over molding to provide a suitable bondage between the top cover and the bottom cover. Moreover, the top cover can be fabricated with a transparent quality to provide for visual notification by illuminating a certain color or brightness on the keypad surface, when for example a particular key has been actuated. An audio herald, alone or in combination with visual indicia can be employed for indicating an operator that a particular item (e.g., item 165_{J}) has been singulated.

The compact handheld singulation component 900 can also include a magnetic strip reader 940 or other data capture mechanism (e.g. a signature and/or biometric capture pad; not shown) such as an infrared wireless interface, USB ports, COM ports, and so on.

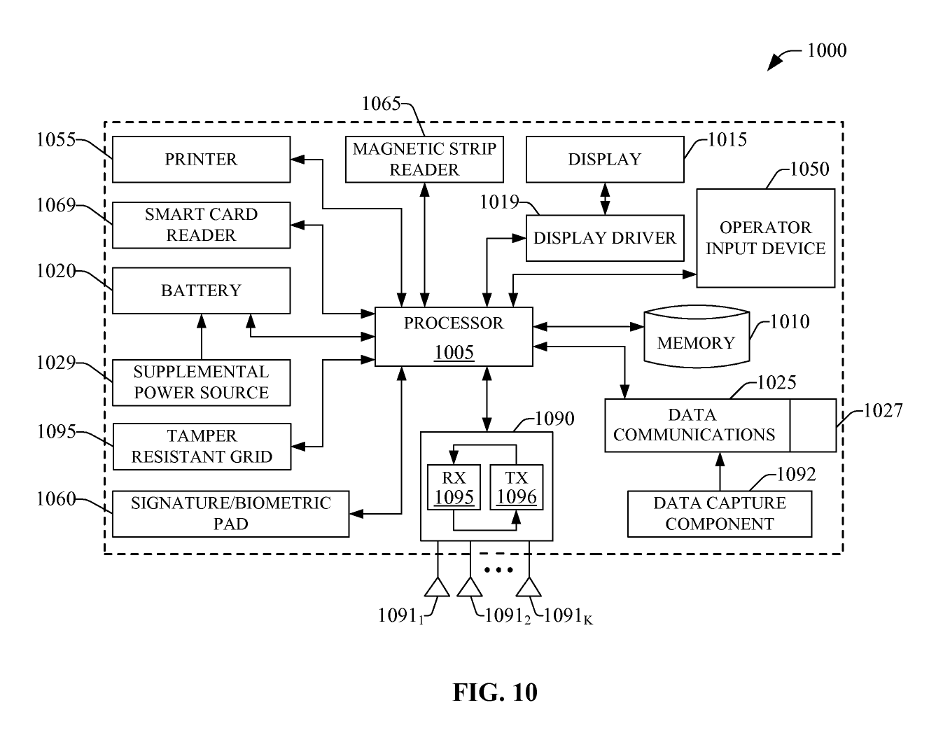

Turning now to FIG. 10, a schematic representation according to one aspect of the subject invention is shown in which a processor 1005 is responsible for controlling the general operation of a handheld terminal that can be utilized as a handheld singulation component. The processor 1005 is programmed to control and operate the various components within the handheld terminal 1000 in order to carry out the various functions described herein. The processor or CPU 1005 can be any of a plurality of suitable processors. The manner in which the processor 1005 can be programmed to carry out the functions relating to the subject invention will be readily apparent to those having ordinary skill in the art based on the description provided herein.

A memory 1010 tied to the processor 1005 is also included in the handheld terminal 1000 and serves to store program code executed by the processor 1005 for carrying out operating functions of the handheld terminal and/or mobile companion 1000 as described herein. The memory 1010 also serves as a storage medium for temporarily storing information such as user defined functions and the like. The memory 1010 is adapted to store a complete set of the information to be displayed. According to one aspect, the memory 1010 has sufficient capacity to store multiple sets of information, and the processor 1005 could include a program for alternating or cycling between various sets of display information.

A display 1015 is coupled to the processor 1005 via a display driver system 1019. The display 1015 can be a liquid crystal display (LCD) or the like, or a monolithic, thin-film based electrochromic display. Display 1015 functions to display data or other information (e.g., Navigation Toolbar 350) relating to specific aspects of operation described herein, e.g. with respect to a singulation component such as component 110, as well as ordinary operation of a handheld terminal 1000. For example, the display 1015 may display suggested configurations, which is displayed to the operator and may be transmitted over a communication links (e.g., links 238_{FL} and 238_{RL}).

Additionally, the display 1015 may display a variety of functions that control the execution of the handheld terminal 1000. The display 1015 is capable of displaying both alphanumeric and graphical characters. Power is provided to the processor 1005 and other components forming the handheld terminal and/or mobile companion 1000 by at least one battery 1020. In the event that the battery(s) 1020 fails or becomes disconnected from handheld terminal 1000, a supplemental power source 1029 can be employed to provide power to the processor 1005. For example, a thin-film solar-cell panel can embody such supplemental power source 1029, such thin-film can coat a portion of the surface of the device. The handheld terminal 1000 can enter a minimum current draw of sleep mode upon detection of a battery failure.

The handheld terminal 1000 includes a communication subsystem 1025 that includes a data communication port 1027, which is employed to interface the processor 1005 with the network via the host computer. The handheld terminal 1000 also optionally includes an RF section 1090 connected to the processor 1005. The RF section 1090 includes an RF receiver 1095, which can receive RF transmissions from the network for example via RL 168_{RL} or 238_{FL} and a set of antennas 1091₁-1091_{K}, and demodulate the signal to obtain digital information modulated therein. The RF section 1090 also includes an RF transmitter 1096 for transmitting information to a computer on the network, for example, in response to an operator input at a operator input device 1050 (e.g., keypad, touch screen) or the completion of a transaction. Peripheral devices, such as a printer 1055, signature/biometrics pad 1060, magnetic strip reader 1065, and data capture device 1092 can also be coupled to the handheld terminal 1000 through the processor 1005. The handheld terminal 1000 can also include a tamper resistant grid 1031 to provide for secure payment transactions. If the handheld terminal is employed as payment terminal, it can be loaded with a special operating system. Moreover, if the handheld terminal 1000 is employed as a general purpose terminal, it can be loaded with a general purpose operating system.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g. hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other computer-readable media for storing information. The term “computer-readable medium” can include, without being limited to, wireless channels and various other media capable of storing, containing, and/or carrying instruction(s) and/or data.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g. that is functionally equivalent), even though not structurally equivalent to the disclosed structure, which performs the function in the herein illustrated exemplary aspects of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising”.

What is claimed is:

1. A system that facilitates identification of an object within a set of objects, the system comprising:
a component that scans a code assigned to an object, wherein the code conveys a unique identifier for the object;
a component that collects data stored in a plurality of tags that identifies each object in a set of objects; and
a cross-reference component that matches the object's unique identifier with a datum in the tag that further identifies the object.

2. The system of claim 1, the component that scans the code assigned to the object is at least one of a laser scanner, a pen light reader, a charge-coupled device imager, or a visible-infrared camera.

3. The system of claim 1, a tag in the plurality of tags that identifies each object in a set of object is a radiofrequency identification tag.

4. The system of claim 3, the component that collects data stored in the plurality of tags that identifies a set of objects is a radiofrequency tag reader.

5. The system of claim 4, the radiofrequency tag reader writes data to the radiofrequency tag.

6. The system of claim 3, the radiofrequency tag is an active RFID tag that is powered by a solar-energy cell.

7. The system of claim 1, wherein the code assigned to an object is a barcode that includes at least one of an object's serial number, a cyclic redundancy check, a multi-bit checksum code, a universally unique identifier.

8. The system of claim 7, wherein the barcode is a linear symbology code that includes at least one of a universal product code, a European article numbering code, a universal standard book numbering code, a rational codabar code, a postal numeric encoding technique code, a shipping container code, a serialized shipping container code, a health care industry barcode code, a code 39 standard, a code 93 standard, or a code 128 standard.

9. The system of claim 8, wherein the barcode is a two-dimensional barcode that includes at least one of a PDF417 code, an Aztec code, a quick response (QR) code, a codablock code, a code 1, a code 16K, a code 49, a CP code, a data glyph code, a datastrip code, a dot code A, a maxicode code, a minicode code, a smartcode code, a supercode code, a snowflake code, an ultracode code, a paperdisk code, or a reduced space symbology code.

10. The system of claim 1, further comprising a data storage that serves as a memory cache for information gathered from the object's code and the data stored in the plurality of tags.

11. The system of claim 1, further comprising a communication framework that facilitates transmission of the collected data and includes at least one of a wired network or a wireless network.

12. The system of claim 11, further comprising a display component that renders the collected data.

13. The system of claim 12, wherein the display component facilitates input of data for a tag in the plurality of tags and communication of the collected and input data among operators and applications associated with an application component that processes said data.

14. A method for identifying an item tag in an object among a set of identification tags, the method comprising:
scanning a unique barcode identifier assigned to an object;
gathering data from a set of identification tags, the set including an item tag associated with the object;
cross-referencing information stored in the barcode identifier assigned to an object with the data gathered from the set of identification tags; and
identifying the ID tag associated with the object when data available in the identification tag matches the information stored in the unique barcode identifier.

15. The method of claim 14, further comprising displaying at least one of the barcode unique identifier assigned to the object or the data available in the identification tag.

16. The method of claim 14, further comprising conveying data available in the identification tag associated with the object to a computer-implemented application for generating actionable information in real time.

17. The method of claim 15, further comprising:
manipulating the available data stored in the identified ID tag associated with the object; and
committing the manipulated data associated with the object in the computer-implemented application for generating actionable information in real time.

18. The method of claim 16, further comprising communicating the manipulated data associated with the object for facilitating trailing the object in real time at disparate locations.

19. The method of claim 14, further comprising:
receiving a reference datum; and
identifying a bin of objects containing an identification tag that carries the reference datum.

20. An apparatus that allows identification of a tagged object, the apparatus comprising:
means for scanning a unique code assigned to a tagged object;
means for retrieving data from a set of radiofrequency identification tags, the set including an RFID tag including an information carried by the unique code;
means for parsing the retrieved data;
means for conveying the retrieved data;
means for displaying the retrieved data; and
means for communicating the retrieved data among at least one of a set of operators or a set of geographic locations.
